(19) United States
(12) Patent Application Publication
(10) Pub. No.: US 2011/0037656 A1
(43) Pub. Date: Feb. 17, 2011

(54) ULTRA WIDEBAND ANTENNA

(75) Inventors: Duncan Bremner, Renfrewshire (GB); Dean Kemp, Surrey (GB); Mark Norris, Cambridge (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI SCOTLAND LIMITED, Glasgow, Scotland (GB)

(21) Appl. No.: 12/596,543

(22) PCT Filed: Apr. 17, 2008
(86) PCT No.: PCT/GB2008/001364

§ 371 Date: Aug. 17, 2010

(30) Foreign Application Priority Data
Apr. 20, 2007 (GB) 0707742.3

(51) Int. Cl. H01Q 1/38

(52) U.S. Cl. 343/700 MS

(57) ABSTRACT

An ultra wideband antenna comprises a substrate (21). A metal layer deposited on the substrate comprises first and second non-metallic regions (22a, 22b) defined therein. The first and second non-metallic regions (22a, 22b) are arranged on either side of a longitudinal axis (X₀), the longitudinal axis (X₀) corresponding to a feed axis of the antenna. The first and second non-metallic regions taper towards the first longitudinal (X₀) to form a bowtie pattern. Each of the first and second non-metallic regions (22a, 22b) comprises at least one tuning slot (31, 33), the at least one tuning slot (31, 33) being arranged about a respective first axis (X₁, X₂), the first axis (X₁, X₂) being parallel to the longitudinal axis (X₀), and wherein the at least one tuning slot extends along its respective axis (X₁, X₂) to form a non-metallic area outside the non-metallic area defined by the respective first and second non-metallic region (22a, 22b). The tapering of the first and second non-metallic regions (22a, 22b) in combination with the at least one pair of tuning slots (31, 33) enables the antenna to be reduced in size, while being capable of operating over at least the UWB frequency range.

### FIELD OF THE INVENTION

The invention relates to an ultra wideband antenna, and in particular to a low cost ultra wideband antenna suitable for use in portable devices.

### BACKGROUND OF THE INVENTION

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of confining communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a multi-band orthogonal frequency division multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organized into five band groups: four having three 528 MHz sub-bands, and one having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example Mobile phones and PDAs, digital cameras and MP3 players, etc.

The large bandwidths and large data rates associated with such applications require an antenna which has excellent characteristics over the whole ultra wideband range. As a result, many ultra wideband systems adopt complex antenna solutions, such as smart antennas or antenna arrays.

However, antennas of this type are not suited for use in small portable devices, since the smart antennas or antenna arrays tend to be relatively large and expensive.

What is needed is an antenna design that can operate consistently across all current legislated band frequencies, having a small footprint, suitable for mass production, and also having a low-cost.

### SUMMARY OF THE INVENTION

According to a first aspect of the invention there is provided an ultra wideband antenna comprising a substrate, and a metal layer deposited on the substrate. The metal layer comprises first and second non-metallic regions defined therein, the first and second non-metallic regions being arranged on either side of a longitudinal axis, the longitudinal axis corresponding to a feed axis of the antenna. The first and second non-metallic regions taper towards the longitudinal axis to form a bowtie pattern. Each of the first and second non-metallic regions comprises at least one tuning slot, the at least one tuning slot being arranged about a respective first axis, the first axis being parallel to the longitudinal axis, and wherein the at least one tuning slot extends along its respective axis to form a non-metallic area outside the non-metallic area defined by the respective first or second non-metallic region.

The antenna according to the invention has the advantage of being able to transmit and receive frequencies over at least the entire UWB frequency range, i.e. at least between 3.1 to 10.6 GHz. Furthermore, the antenna structure has a compact footprint for integration into consumer equipment.

Preferably the antenna substrate is made from FR4 PCB material. This has the advantage of being low cost, and compatible with major PCB processes and techniques.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the arrangement of frequency bands in a multi-band orthogonal frequency division multiplexing (MB-OFDM) system for ultra-wideband communication.

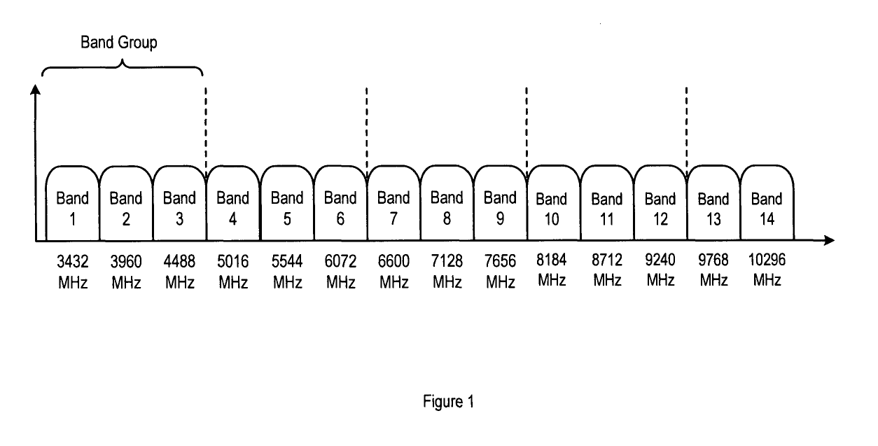

FIG. 2 shows a perspective view of an antenna according to an embodiment of the present invention;

FIG. 3 shows a plan view of the antenna shown in FIG. 2; and

FIG. 4 shows a plan view of an antenna according to another embodiment of the present invention.

### DETAILED DESCRIPTION OF PREFERRED EMBODIMENTS OF THE PRESENT INVENTION

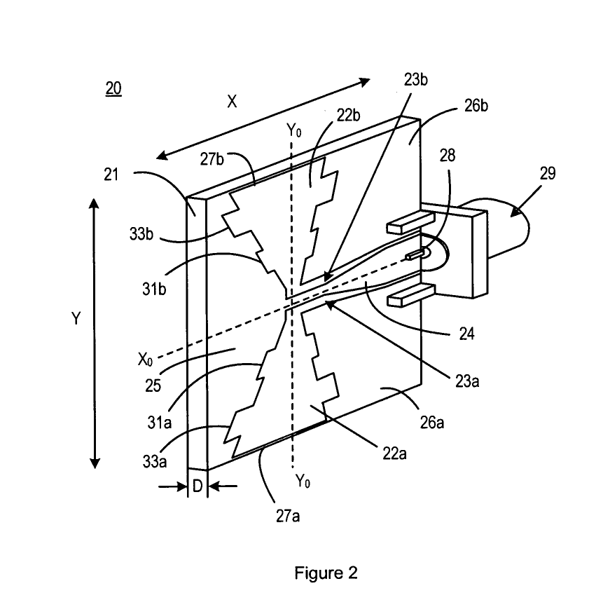

FIG. 2 shows an antenna 20 according to an embodiment of the present invention. The antenna 20 is a planar antenna formed on a substrate 21. The antenna 20 has a footprint of about 30 mm in the “X” direction by about 31 mm in the “Y”. It will be appreciated that these dimensions, including other dimensions described within the remainder of this application, are provided as examples only, and that the invention is equally applicable to antenna arrangements having different dimensions. The dimensions and tolerances are provided as examples associated with low cost fabrication techniques, yet providing an antenna structure that has robust wideband performance compatible with such mass production techniques.

The substrate 21 is made from a suitable material, for example a PCB material such as FR4. FR4 substrate material has the advantage of being low cost and easy to manufacture. FR4 is a woven glass reinforced epoxy resin laminate and is the usual base material for PCB laminates. FR4 laminate displays a reasonable compromise between mechanical, electrical and thermal properties. The dimensional stability is influenced by construction and resin content. The dielectric constant, typically in the range 4.4 to 5.2, depends on the glass-resin ratio. This value decreases with increasing resin content and increasing frequency. As such, the use of FR4 as an antenna substrate is normally restricted to frequencies in the lower microwave band since dielectric losses usually make FR4 unsuitable for higher frequencies, which means that other substrate materials are usually used for such applications. However, as will be described hereinafter, the antenna structure and design according to the present invention means that the antenna 20 is suitable for use in the ultra wideband frequency range using a substrate 21 made from FR4 material.

The substrate 21 has a single sided coating of a metal conductor, for example a 1 oz coating of copper. The substrate 21 shown in FIG. 2 has a thickness D of about 1.6 mm, although it will be appreciated that other thicknesses may also be used, as may other conductive materials such as gold or aluminium. It will be appreciated that the thickness of the substrate will affect the return loss across the frequency band. The structure of the embodiment of FIG. 2 is therefore described in relation to the tolerances required for compatibility with commercial off-the-shelf materials such as FR4, and as such the tolerances and dimension may vary when the invention is applied to an antenna using a substrate made from a different material.

The antenna structure is formed by creating non-metallic regions in the metal coating on the surface of the substrate. In particular, the metal coating on the substrate 21 is processed to provide first and second non-metallic regions 22a and 22b, the first and second non-metallic regions 22a and 22b having corresponding first and second non-metallic channels 23a and 23b connecting the first and second non-metallic regions to the edge of the substrate that is nearest the antenna feed.

In the embodiment of FIG. 2 the first and second non-metallic regions 22a and 22b are generally triangular in shape with their apexes facing each other, and together with the first and second non-metallic channels 23a, 23b define an antenna structure having a bowtie shaped tuning slot. It will be appreciated by a person skilled in the art that the triangular shaped first and second non-metallic regions 22a, 22b may be replaced by non-metallic regions having other shapes that taper towards an apex, for example a curved shaped profile in place of the triangular one shown in the Figures.

The first and second non-metallic regions 22a, 22b and/or the first and second non-metallic channels 23a, 23b are preferably symmetrical about an axis X₀ (referred to hereinafter as the “vertical axis” or “longitudinal axis” corresponding to a feed axis of the antenna).

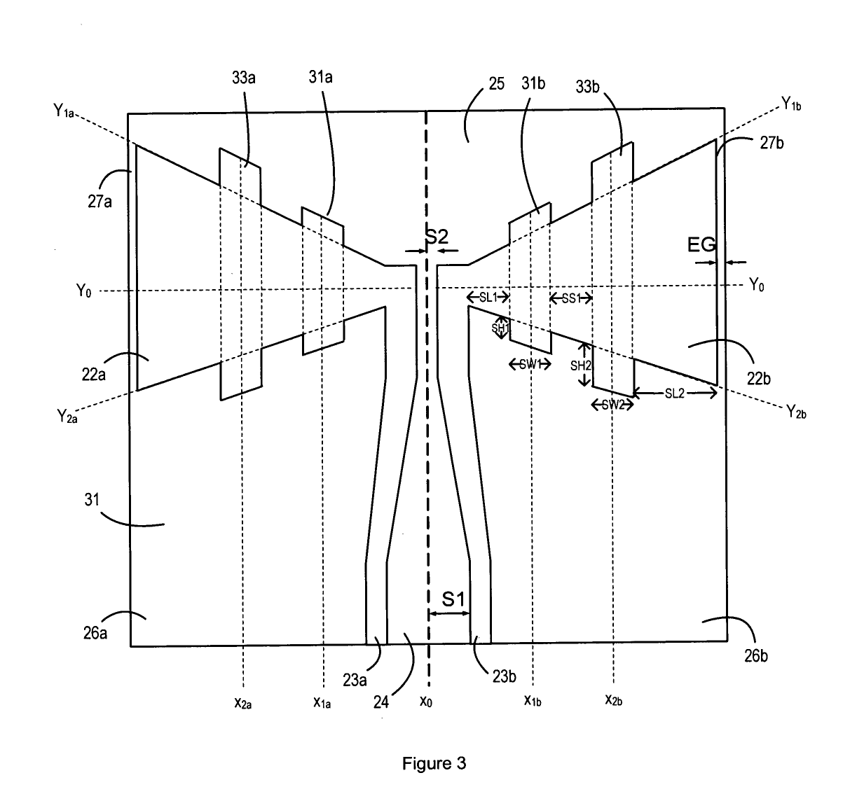

As can be seen from FIG. 2, each of the first and second non-metallic regions 22a, 22b comprises at least one tuning slot (31a, 33a; 31b, 33b) formed in the generally triangular areas. In FIG. 2 each of the first and second non-metallic regions 22a, 22b is shown as having a first tuning slot 31a, 31b, respectively, and a second tuning slot 33a, 33b, respectively. The tuning slots in combination with the tapering of the first and second non-metallic regions enable the antenna to be reduced in size, yet used with the wide range of frequencies required by ultra wideband devices. The tuning slots 31a, 31b, 33a, 33b are described in greater detail below in relation to FIG. 3. The non-metallic areas formed by the first and second non-metallic regions 22a, 22b, the non-metallic channels 23a, 23b and the plurality of tuning slots form the following metallic regions (i.e. metallic regions which remain on the substrate after creation of the various non-metallic regions).

A first metallic region corresponds to a co-planar antenna feed region 24 which, during use, is connected to receive the positive signal from the antenna feed point 28. The antenna feed region 24 is connected to a first radiating portion 25, which is generally triangular in shape and having its apex connected to the antenna feed region 24. The first radiating portion 25 is connected to second and third radiating portions 26a and 26b via respective first and second edge portions 27a and 27b. The second and third radiating portions 26a and 26b are connected, during use, to a ground connection of the antenna signal. In FIG. 2 the antenna is shown as being connected to an SMA end launcher feed 29, which is typically used for connecting an antenna signal to an antenna structure (for example using a co-axial cable). The first metallic region 24, i.e. defined by the first and second non-metallic channels 23a, 23b, acts as an impedance changer to interface the higher antenna impedance to the defined 50 ohm single ended source.

The metallic coating may be removed to form the first and second non-metallic regions 22a, 22b, the first and second non-metallic channels 23a, 23b and the tuning slots 31a, 31b, 33a, 33b using a PCB milling machine, for example, which is capable of accurately milling the 1 oz surface copper of FR4 with an accuracy of 0.1 mm, using cutters with diameters as small as 0.25 mm. The geometry of the antenna may be defined by CAD inputs, either in DXF or Gerber format, and are converted into a machine readable format for input to the milling machine. It is also possible to accurately cut the substrate material using machine routers that come in a variety of sizes.

Alternative techniques may also be used to create the non-metallic portions, including the possibility of etching the metallic layer using chemicals or processes used for producing printed circuit boards.

It will be appreciated from the above that, in contrast to known antenna designs, the bowtie in the present invention is made from non-metallic material (i.e. compared to traditional bowtie arrangements in which the bowtie itself is made from the conducting material). Tuning of the antenna may be required when enclosed by a structure, for example a radome, or when the antenna is in close proximity to objects. Tuning the antenna may involve minor modification of the complete geometry in view of the interdependency of the various features of the structure.

The antenna described above is suited for use over at least the whole UWB frequency range due to the complementary action of the overall taper of the non-metallic regions 22a, 22b and purposely designed tuning slots 31a, 31b, 33a, 33b. These features help facilitate pure radiation modes, and minimise the amount of residual energy likely to stay within the structure (which set strong standing waves and reduce bandwidth).

FIG. 3 shows a plan view of the antenna design according to an embodiment of the present invention.

As described in FIG. 2, first and second non-metallic regions 22a and 22b are formed in the metal coating on the surface of the substrate 21, the first and second non-metallic regions 22a and 22b having corresponding first and second non-metallic channels 23a and 23b connecting the first and second non-metallic regions 22a, 22b to the edge of the substrate that is nearest the antenna feed.

The first and second non-metallic regions 22a, 22b and first and second non-metallic channels 23a, 23b are preferably symmetrical about a longitudinal axis X₀ (i.e. the axis corresponding to the axis of the antenna feed).

A first pair of tuning slots 31a and 31b is formed on a respective first pair of axes X₁ₐ, X_{1b}. The first pair of tuning slots 31a, 31b are arranged on the first pair of axes X₁ₐ, X_{1b}, such that the tuning slots 31a, 31b extend along their respective axes X₁ₐ, X_{1b} to form a non-metallic area outside the non-metallic area defined by the respective first and second non-metallic regions 22a, 22b.

A second pair of tuning slots 33a and 33b is formed on a respective second pair of axes X₂ₐ, X_{2b}. The second pair of tuning slots 33a, 33b are arranged on the second pair of axes X₂ₐ, X_{2b}, such that the tuning slots 33a, 33b extend along their respective axes X₂ₐ, X_{2b} to form a non-metallic area outside the non-metallic area defined by the respective first and second non-metallic regions 22a, 22b.

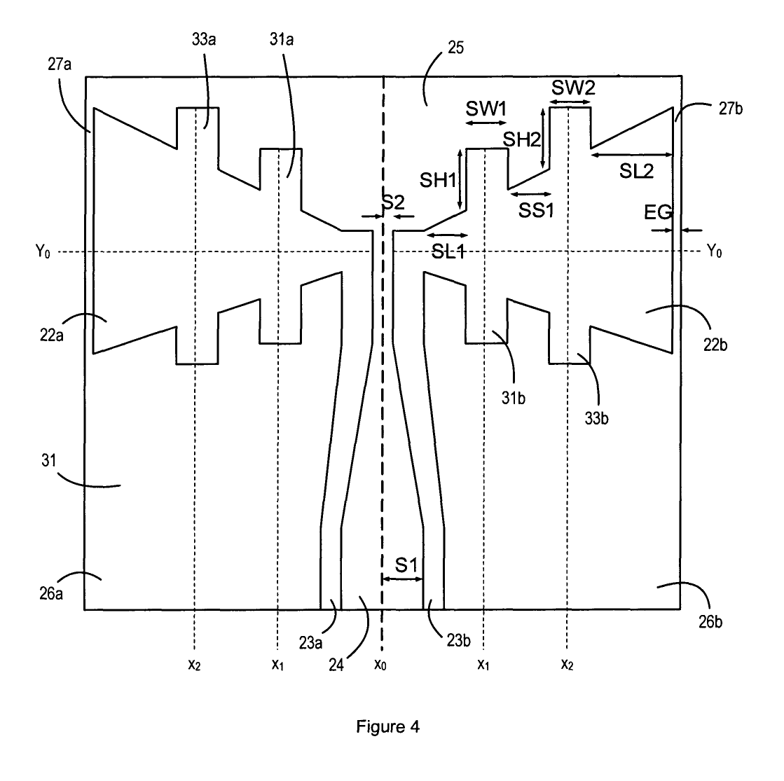

In the embodiment of FIG. 3 the respective ends of the tuning slots 31a, 31b, 33a, 33b are shown as being non-parallel to the axis Y₀, resulting in tuning slots having a trapezium or trapezoid shape. However, it is noted that the respective ends of the tuning slots 31a, 31b, 33a, 33b may be arranged such that they are parallel to the axis Y₀, for example as shown in FIG. 4, resulting in tuning slots having a rectangular shape.

In the embodiment of FIG. 3, the magnitude of the gradient of the upper side of the non-metallic region 22a (i.e. along axis Y₁ₐ) is larger than the magnitude of the gradient of the lower side of the non-metallic region 22a (i.e. along axis Y₂ₐ). Similarly, the magnitude of the gradient of the upper side of the non-metallic region 22b is larger than the magnitude of the gradient of its lower side. As mentioned above, the ends of the tuning slots 31a, 31b, 33a, 33b may be arranged such that they are non-parallel to the axis Y₀. For example, in FIG. 3 the ends of the tuning slots are arranged such that they are parallel with the respective axes Y₁ₐ, Y₂ₐ, Y_{1b} and Y_{2b}.

The dimensions of the first and second pairs of tuning slots 31a/31b and 33a/33b will now be described. It will be appreciated that these dimensions are only examples, and that other dimensions may be used without departing from the scope of the invention. Each tuning slot 31a/31b in the first pair has a width SW1 of about 2.83 mm ±10%, and a height SH1 of about 1.00 mm ±10%. It can be seen that the height SH1 is provided from where the end of a tuning slot 31a/31b meets the edge of the triangular shape defined by the non-metallic regions 22a/22b, respectively. Each tuning slot 31a/31b is positioned a distance SL1 from the respective first and second non-metallic channels 23a, 23b. The distance SL1 is about 2.83 mm ±10%.

Each tuning slot 33a/33b in the second pair has a width SW2 of about 2.98 mm ±10%, and a height SH2 of about 2.30 mm ±10%. It can be seen that the height SH2 is provided from where the end of a tuning slot 33a/33b meets the edge of the triangular shape defined by the non-metallic regions 22a/22b, respectively. Each tuning slot 33a/33b in the second pair is positioned a distance SL2 from the outer edge of the respective first and second non-metallic regions 22a, 22b. The distance SL2 is about 2.14 mm ±10%.

A tuning slot 31a/31b in the first pair is separated from a tuning slot 33a/33b in the second pair by a distance SS1 of about 2.70 mm ±10%.

Each edge portion 27a, 27b is about 0.33 mm wide ±10%. The first and second non-metallic channels 23a and 23b are separated from the axis X₀ by a distance S1 near the point where the antenna feed is provided. The distance S1 is about 4.17 mm ±10%. The first and second non-metallic channels 23a and 23 are separated from the longitudinal axis X₀ by a distance S2 near the apexes of the first and second non-metallic regions 22a and 22b. The distance S2 is about 1.28 mm ±10%. From the above it can be seen that the feed separation near the antenna feed is greater than the feed separation near the first and second non-metallic regions 22a and 22b. This arrangement defines a co-planar antenna feed region 24 which becomes progressively narrower along the longitudinal axis X₀ away from the antenna feed point, until it reaches the first radiating portion 25.

As mentioned above, the dimensions and tolerances provided above are examples only, and it will be appreciated that other variations are possible without departing from the scope of the invention as defined in the appended claims.

The impact on return loss due to tolerances has been performed numerically on the exemplary antenna dimensions of the above design. It will be appreciated that the antenna consists of a large number of optimised variables that contribute to the overall performance of the design. Table 1 below provides an indication of the performance variance caused by the tolerances of the variables described in relation to FIG. 3.

TABLE 1
Tolerance analysis of bowtie slot antenna

| | | Value | Degradation of worst |
|---|---|---|---|
| Variable | Description | (mm) | case return loss (dB) |
| SH2 | Tuning slot height 2 | 2.30 ± 10% | 1.1 |
| S1 | Feed separation 1 | 4.17 ± 10% | 1.0 |
| SL2 | Tuning slot length 2 | 2.14 ± 10% | 0.6 |
| SS1 | Slot separation | 2.70 ± 10% | 0.6 |
| S2 | Feed separation 2 | 1.28 ± 10% | 0.3 |
| EG | Edge gap | 0.33 ± 10% | 0.2 |
| SH1 | Tuning slot height 1 | 1.00 ± 10% | 0.1 |
| SW2 | Tuning slot width 2 | 2.98 ± 10% | 0.1 |
| SL1 | Tuning slot length 1 | 2.83 ± 10% | 0.05 |
| SW1 | Tuning slot width 1 | 2.83 ± 10% | 0.05 |

The table provides a worst case degradation in return loss for these values. The parameters are placed in order of their degradation effect on the return loss. As can be seen from Table 1, the critical parameters from this analysis are the tuning slot properties, especially the second pair of tuning slots 33a/33b, and the feed separation S1. The dimensions of the second pair of tuning slots 33a/33b have a significant effect at both the low and high frequencies regions, where changes produce up to a 1 dB reduction in return loss. These changes are due to the resonant behaviour of the second slots 33a/33b being altered and hence having a deleterious effect on the overall performance.

Similar degradation effects also occur if the co-planar antenna feed region 24 is altered, where the return loss can degrade by up to 1.1 dB. This degradation is due to an increased mismatch between the co-planar antenna region 24 and the impedance of the antenna feed, which is normally 50Ω. The other variables listed in Table 1 have less effect on the performance of the antenna, such as the first pair of tuning slots 31a/31b or edge gaps 27a/27b. It is noted, however, that the tolerance analysis has been limited to ±10% of the nominal design, and it will be appreciated that increases to this value may produce a higher degree of degradation.

The planar antenna described above in the preferred embodiment has the advantage of being small in size, yet able to transmit and receive frequencies over at least the entire UWB frequency range, i.e. at least between 3.1 to 10.6 GHz. This is achieved by the combination of the tapering of the non-metallic regions 22a, 22b in conjunction with the one or more pairs of tuning slots 31a/31b and/or 33a/33b.

The antenna structure also has the advantages of being fabricated using extremely cheap FR4 PCB material, and of being compatible with major PCB processes and techniques. Furthermore, the antenna structure has a compact footprint and is low profile for integration into consumer equipment.

The antenna design also has the advantage of providing consistent characteristics across the UWB frequency band, while being optimised around the centre-band frequency of 6.85 GHz

It is noted that, although the preferred embodiment is described in relation to using FR4 PCB material for the substrate, the invention can be used with other suitable materials forming the substrate, for example materials having a lower loss. It will be appreciated that the use of other materials may require the physical dimensions to be adjusted to compensate for the different electrical properties (for example different dielectric constant) of the different material. It will also be appreciated by a person skilled in the art that the main radiation is at the surface to air interface, with the dielectric playing a secondary role in defining the dimensions, apart from the short section of coplanar waveguide transmission line shown as the channels 23a and 23b.

The invention also contemplates the antenna being fabricated to be free standing on a suitable planar material. The free standing antenna may be formed by fabricating the metal coating on a substrate and then removing the substrate. In addition, the antenna may be constructed on or from a flexible material which may be designed to be “wrapped” around the edge of an enclosure of an UWB device.

It is also noted that the antenna described above could be arranged to operate on top of a screen, for example a CRT/LCD screen or a screen made from fabric or any other material. Such an arrangement provides directivity enhancement. The antenna may also be arranged to operate as a feed of a corner or parabolic reflector.

Although the embodiments shown in FIG. 3 and FIG. 4 are described as having tuning slots 31a, 31b, 33a, 33b which are shaped as a trapezium, trapezoid or rectangle, it is noted that the tuning slots may have other configurations that extend out from the area defined by the non-metallic regions 22a, 22b, For example, the tuning slots 31a, 31b, 33a, 33b may be triangular or curved in shape. Also, the antenna may have more or fewer tuning slots than the number shown in the embodiments above.

Furthermore, although the described embodiments show the tuning slots extending out from above and below the non-metallic regions 22a, 22b, it will be appreciated that the tuning slots may extend from the non-metallic region 22a, 22b in one direction only, for example either above or below the non-metallic region 22a, 22b.

In addition, although the tuning slots are described as lying on axes that are parallel to the longitudinal axis, the tuning slots may lie of other axes, or lie on axes that are non-parallel with respect to each other.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single unit may fulfil the functions of several units recited in the claims. Any reference signs in the claims shall not be construed so as to limit their scope.

1. An ultra wideband antenna comprising:
a substrate;
a metal layer deposited on the substrate;
wherein the metal layer comprises first and second non-metallic regions defined therein, the first and second non-metallic regions being arranged on either side of a longitudinal axis (X₀), the longitudinal axis (X₀) corresponding to a feed axis of the antenna, the first and second non-metallic regions tapering towards the longitudinal axis (X₀) to form a bowtie pattern;
wherein each of the first and second non-metallic regions comprises at least one tuning slot, the at least one tuning slot being arranged about a respective first axis (X₁, X₂), the first axis (X₁, X₂) being parallel to the longitudinal axis (X₀);
and wherein the at least one tuning slot extends along its respective axis (X₁, X₂) to form a non-metallic area outside the non-metallic area defined by the respective first or second non-metallic region.

2. An antenna as claimed in claim 1, wherein the first non-metallic region is a mirror image of the second non-metallic region about the longitudinal axis (X₀).

3. An antenna as claimed in claim 1, further comprising first and second non-metallic channels, the first and second non-metallic channels connecting the first and second non-metallic regions to an edge of the substrate.

4. An antenna as claimed in claim 3, wherein the first non-metallic channel is a mirror image of the second non-metallic channel about the longitudinal axis (X₀).

5. An antenna as claimed in claim 3, wherein the first and second non-metallic channels connect with the first and second non-metallic regions near an apex of the first and second non-metallic regions.

6. An antenna as claimed in claim 3, wherein the first and second non-metallic channels form a co-planar feed region in the metal layer along the longitudinal axis (X₀).

7. An antenna as claimed in claim 6, wherein the co-planar feed region is connected to a first radiating portion, the first radiating portion having an apex connected to the co-planar feed region.

8. An antenna as claimed in claim 7, further comprising second and third radiating portions, the second and third radiating portions arranged on either side of the longitudinal axis (X₀), and being connected to the first radiating portion via edge portions provided along the periphery of the substrate.

9. An antenna as claimed in claim 6, wherein the co-planar feed region is connected, during use, to a positive antenna signal.

10. An antenna as claimed in claim 8, wherein the second and third radiating portions are connected, during use, to a ground connection of the antenna signal.

11. An antenna as claimed in claim 1, wherein each of the first and second non-metallic regions comprises first and second tuning slots, each of the first tuning slots being arranged about a respective first axis (X₁ₐ, X_{1b}), and each of the second tuning slots being arranged about a respective second axis (X₂ₐ, X_{2b}).

12. An antenna as claimed in claim 11, wherein each of the first tuning slots and each of the second tuning slots have substantially parallel sides to the respective first axis (X₁ₐ, X_{1b}) and the respective second axis (X₂ₐ, X_{2b}).

13. An antenna as claimed in claim 12, wherein the width of the second tuning slot about the second axis (X₂ₐ X_{2b}) is greater than the width of the first tuning slot about the first axis (X₁ₐ, X_{1b}).

14. An antenna as claimed in claim 13, wherein the width of the second tuning slot is in the range of about 5.36 mm to about 6.55 mm.

15. An antenna as claimed in claim 13, wherein the width of the first tuning slot is in the range of about 5.09 mm to about 6.23 mm.

16. An antenna as claimed in claim 6, wherein the width of the co-planar feed region becomes narrower along the longitudinal axis (X₀) away from the edge of the substrate which receives an antenna feed.

17. An antenna as claimed in claim 16, wherein the width of the co-planar feed region at the end near the antenna feed is in the range of about 7.50 mm to about 9.17 mm.

18. An antenna as claimed in claim 16, wherein the width of the co-planar feed region at the end away from the antenna feed is in the range of about 2.30 mm to about 2.82 mm.

19. An antenna as claimed in claim 1, wherein the first and second non-metallic regions are generally triangular in shape.

20. An antenna as claimed in claim 19, wherein the magnitude of the gradient of an upper side of the first and second non-metallic regions is larger than the magnitude of the gradient of the lower side of the first and second non-metallic regions, the lower side being the side nearest to an antenna feed.

21. An antenna as claimed in claim 1, wherein the first and second tuning slots are generally triangular in shape.

22. An antenna as claimed in claim 1, wherein the first and second tuning slots are generally trapezoidal or trapezium in shape.

23. An antenna as claimed in claim 1, wherein the first and second tuning slots are generally circular in shape.

24. An antenna as claimed in claim 1, wherein the substrate is made from FR4 PCB material.

25. An antenna as claimed in claim 24, wherein the substrate is planar.

26. An antenna as claimed in claim 1, wherein the substrate is made from a flexible material.

27. An antenna as claimed in claim 1, wherein the substrate is removed after forming the non-metallic regions.
